(19) United States
(12) Patent Application Publication
(10) Pub. No.: US 2010/0223572 A1
(43) Pub. Date: Sep. 2, 2010

(54) Creating Manager Views In An Employee Compensation System

(75) Inventors: Anadi Upadhyaya, Hyderabad (IN); Ty Hayden, Grand Junction, CO (US)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/394,361

(22) Filed: Feb. 27, 2009

(51) Int. Cl. G06F 3/048

(52) U.S. Cl. 715/777; 715/764; 715/227

(57) ABSTRACT

Systems, methods, and software applications for setting up manager views of a compensation management page are described in the present disclosure. According to one embodiment, among many, a computer readable medium is configured to store instructions that are executable by a processing device. The computer readable medium in this embodiment includes logic adapted to enable a user to group a plurality of manager views, wherein the layouts of the pages are to be set up by the user. The computer readable medium further includes logic adapted to enable a user to define the layout of each of the plurality of manager views and logic adapted to enable a user to define one or more columns of each manager view. The user can set up and define the manager views without affecting actual compensation data.

### TECHNICAL FIELD

The present disclosure generally relates to compensation software applications for handling compensation information for employees of an enterprise. More particularly, the embodiments described herein relate to systems and methods for creating pages that are accessible by a manager while using the compensation software.

### BACKGROUND

Many corporations use compensation software to manage the salaries, bonuses, and other types of compensation for a number of employees of an organization or enterprise. Based on several factors, such as work experience, work performance, position, etc., the compensation software can be run to determine pay increases, bonuses, etc. A compensation administrator may be responsible for setting up configurable parameters within the compensation software. The software is then distributed throughout the organization to managers who may be responsible for making decisions about compensation for several employees who report to the respective manager.

### SUMMARY

The present disclosure describes several embodiments of systems, methods, and processing logic for managing compensation information. Regarding one particular embodiment, a computer readable medium is configured to store instructions that are executable by a processing device. The computer readable medium in this embodiment comprises logic adapted to enable a user to group a plurality of manager views, the layouts of which are to be set up by the user. Also included is logic adapted to enable a user to define the layout of each of the plurality of manager views. Furthermore, the computer readable medium includes logic adapted to enable a user to define one or more columns of each manager view. The user can set up and define the manager views without affecting actual compensation data.

Other features, advantages, and implementations of the present disclosure, not expressly disclosed herein, will be apparent to one of ordinary skill in the art upon examination of the following detailed description and accompanying drawings. It is intended that such implied implementations of the present disclosure be included herein.

### BRIEF DESCRIPTION OF THE DRAWINGS

The components of the following figures are illustrated to emphasize the general principles of the present disclosure. Reference characters designating corresponding components are repeated as necessary throughout the figures for the sake of consistency and clarity.

FIG. 1 is a block diagram illustrating a computing system according to one embodiment.

FIG. 2 is a block diagram illustrating the compensation module shown in FIG. 1, according to one embodiment.

FIG. 3 is a diagram illustrating a graphical user interface (GUI) allowing a user to configure the layout of a compensation management page, according to one embodiment.

FIGS. 4 and 5 are diagrams illustrating GUIs for enabling a user to arrange the grouping of a number of manager views, according to some embodiments.

FIG. 6 is a diagram illustrating a GUI for enabling a user to copy a layout of a compensation management page from another plan, according to one embodiment.

FIGS. 7-10 are diagrams illustrating GUIs for enabling a user to configure a page layout for a specific manager view, according to some embodiments.

FIGS. 11-15 are diagrams illustrating GUIs for enabling a user to configure properties of a specific column of a manager view, according to some embodiments.

FIG. 16 is a diagram illustrating a number of examples of manager views of a compensation management page set up by a user, according to some embodiments.

FIGS. 17A and 17B, cumulatively, are a flow diagram illustrating a computer implemented method for setting up manager views, according to one embodiment.

### DETAILED DESCRIPTION

Compensation software applications are used by organizations, corporations, enterprises, etc., to manage the salaries, bonuses, and other types of compensation for a plurality of employees. Usually, a compensation administrator sets up various configurable properties for the compensation software applications. Particularly, the compensation administrator may control the various pages and views that a manager can access. When the pages and views of the compensation software applications are set up, the software application and relevant pages and views can be distributed to the managers of the organization. By accessing the pages and views set up by the compensation administrator, the managers can perform specific compensation tasks, such as controlling salary changes, distributing bonuses, and other tasks related to compensation for a certain set of employees, such as those who report directly or indirectly to the respective manager.

Conventional compensation software normally would not allow a user to set up manager views without a participation process run, which involves the running of the software on actual compensation data of a number of participants. Therefore, the user would have to access an allocation worksheet to configure manager views, which normally requires a participation process run. In contrast, according to the embodiments described in the present disclosure, a compensation administrator or other user can set up and define the manager views during a set-up process without actually running the software with real data.

The compensation software applications described herein enable a user, such as a compensation administrator, to form a grouping of a plurality of views that can be accessed and viewed by a manager. For example, the group of views can be displayed on a single compensation management page in a multi-tab format, which can provide an intuitive way for the managers to navigate from one view to another. Based on the way the user arranges the groupings, groups of views can vary from one compensation plan to another. Hence, there may be different grouping arrangements for different plans such as Salary, Bonus, Stocks, etc. The software applications described with respect to the embodiments of the present disclosure also allow the user to copy a layout of a compensation management page from another compensation plan. Essentially, this includes copying the grouping or layout of views that have already been prepared into a new compensation management plan. In this way, the user can copy what has already done before and does not have to start from scratch.

The user can further configure or define properties for each individual view. For example, the user can control the order and name of a number of columns to be displayed on each view. Furthermore, by using the compensation software applications described herein, the user can configure each column of a particular manager view. Also, the same column in one view may be configured differently in another view, if the user desires. This gives the user the flexibility to configure a column in different ways, as needed.

The compensation software applications also allow the user to configure summary information about certain employees under a manager's supervision. Also, by interacting with the user interfaces or worksheets of the compensation software applications, the user can configure actions that a manager can perform. Also, it can be possible with the embodiments described herein to hide certain actions for particular pages or views.

Until now, it was not possible to define general and advanced properties of columns of manager views accessible by the managers. A non-limiting list of general properties that are configurable by the user may include, for example, Numeric Display Format, Rounding Code, Column Shading, Decimals to Display, instructional text for columns, etc. A non-limiting list of advanced properties that are configurable by the user may include, for example, Default Values (initial values for a column), Dynamic Calculation (automatic derivation of a value for one column from entry or update of values in one or more other columns), Element Mapping (indication of whether a column is passed as an element entry or passed on to payroll), etc.

The embodiments described herein can also utilize numeric columns and even non-numeric columns, such as text and date information. In this regard, a character recognition program can be run to identify various alphanumeric characters. Alphanumeric columns can be obtained using string concatenation and a date column can also be derived based on other date columns. Also, numeric dynamic columns can be marked as “monetary” and can be used in currency conversion. Numeric or non-numeric column values can be derived based on user settings or default settings from any suitable source.

Although the embodiments described in the present disclosure are primarily directed to software applications, it should be recognized that the embodiments can apply to any type of logic processing systems and methods, which may include any combination of software, hardware, and/or firmware. In addition, although the embodiments described herein define aspects of processing compensation information, it should also be recognized that the embodiments can also pertain to any type of logical processing.

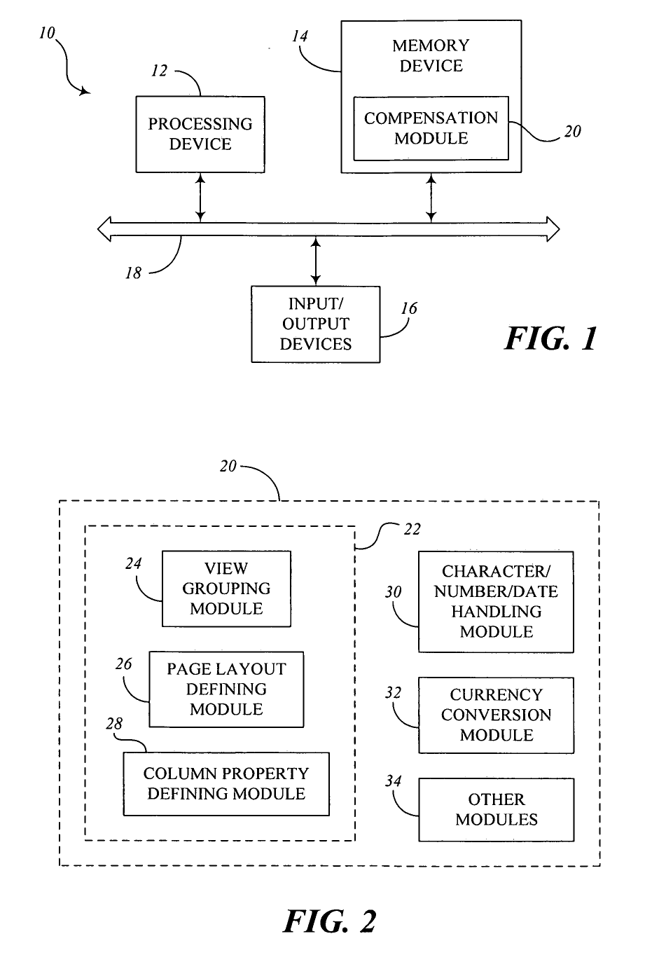

FIG. 1 is a block diagram of one embodiment of a computing system 10. Particularly, computing system 10 may be a computer, data processing system, or other suitable electronic device for executing logic instructions, e.g., software applications. In the embodiment shown in FIG. 1, computing system 10 includes a processing device 12, a memory device 14, and input/output devices 16, each interconnected via a bus interface 18. Memory device 14 includes, among other things, a compensation module 20.

Processing device 12 may be a general-purpose or specific-purpose processor or microcontroller. Memory device 14 may include one or more internally fixed storage units, removable storage units, and/or remotely accessible storage units. Also, memory device 14 may include any suitable combination of volatile memory and/or non-volatile memory and can be configured to store information, data, instructions, and/or software code. Input/output devices 16 may include input mechanisms such as keyboards, keypads, cursor control devices, or other data entry devices. The input mechanisms enable a user to enter information or instructions in computer system 10. Input/output devices 16 may also include output devices, such as computer monitors, display screens, audio output devices, printers, or other peripheral devices for communicating information to the user.

Generally, computing system 10 can include processing means for handling compensation information for a corporation, enterprise, or other entity. More specifically, computing system 10 can include logic adapted to enable a user to set up views within the compensation software that may be accessed by a manager. The set-up logic can allow the user to set up a grouping of manager views, configure the layout of the views, and enter advanced properties related to the columns of the views. Particularly, a view grouping module can be part of the processing means to enable a user to easily group, define, name, and order a number of manager views selectable from a compensation management page. Furthermore, the processing means of computing system 10 also includes, among other components, a page layout defining module, which allows a user to configure the details of the various manager views of the compensation management page. Also, the processing means can include a column property defining module for enabling the user to enter or select advanced properties about specific columns of the manager views.

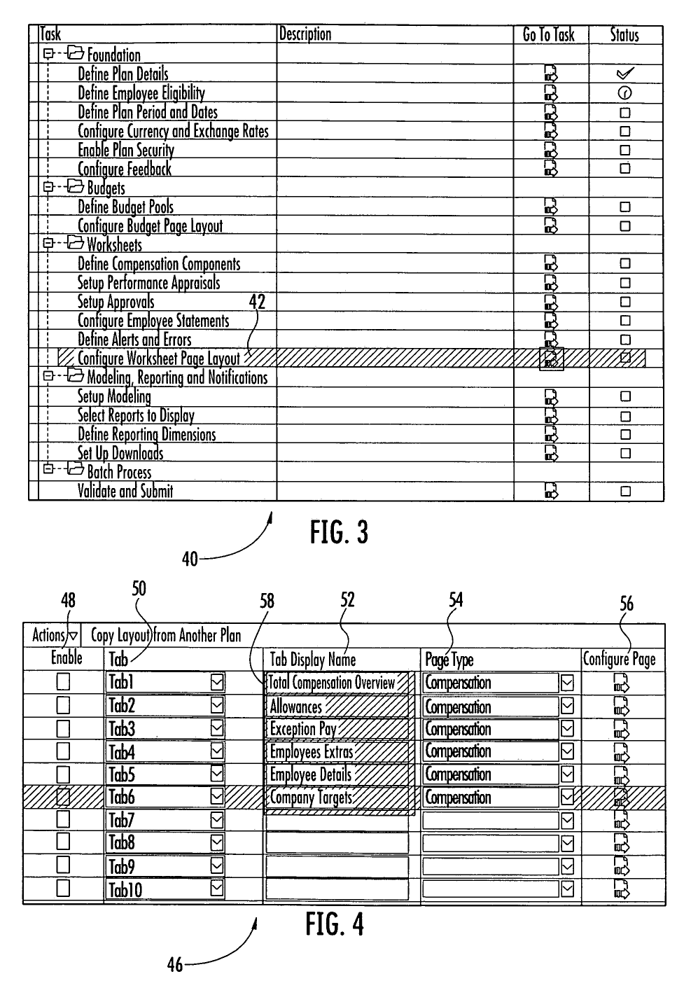

FIG. 2 is a block diagram showing an embodiment of compensation module 20 shown in FIG. 1. In this embodiment, compensation module 20 includes a set-up module 22 having a view grouping module 24, a page layout defining module 26, and a column property defining module 28. Compensation module 20 also includes a character/number/date handling module 30, a currency conversion module 32, and other modules 34. The other modules 34 may include normal compensation logic for accomplishing typical compensation management operations and functions.

The embodiments of compensation module 20 described in the present disclosure can be implemented in hardware, software, firmware, or a combination thereof. When implemented in software or firmware, compensation module 20 can be stored in memory device 14 (as shown in FIG. 1) and executed by processing device 12. Alternatively, when implemented in hardware, compensation module 20 can be implemented in processing device 12 using discrete logic circuitry, an application specific integrated circuit (ASIC), a programmable gate array (PGA), a field programmable gate array (FPGA), or any combination thereof.

Compensation module 20, in addition to other software, computer programs, or logic code that includes executable logical instructions as described herein, can be embodied in a computer-readable medium for execution by any suitable processing device. The computer-readable medium as described herein can include one or more suitable physical media components that can store the software, programs, or code for a measurable length of time.

Set-up module 22 enables a user to set up and define several different aspects of the manager views that can be presented to the managers using compensation module 20. More particularly, set-up module 22 can be accessed and run without a participation process run that involves real compensation data. Therefore, the manager views can be defined during the set-up process of set-up module 22 without actually running other modules that may affect real compensation data.

View grouping module 24 enables a user to set up and organize a number of manager views using a graphical user interface (GUI), worksheet, or spreadsheet. According to some implementations, view grouping module 24 may be associated with the GUIs shown in FIGS. 4-6, as described in more detail below. With view grouping module 24, the user can select to copy pre-defined views from another plan or to create a new set of views. Also, view grouping module 24 allows the user to group certain information into separate views to allow customization of the grouping of information. View grouping module 24 also allows the user to define how each view appears and to name each view. Further, the order that the views are arranged on a compensation management page and how they are ordered on a number of tabs on the compensation management page can also be set up using view grouping module 24. Thus, from the general page, i.e., the compensation management page, a manager can select any tab in order to view the respective manager view.

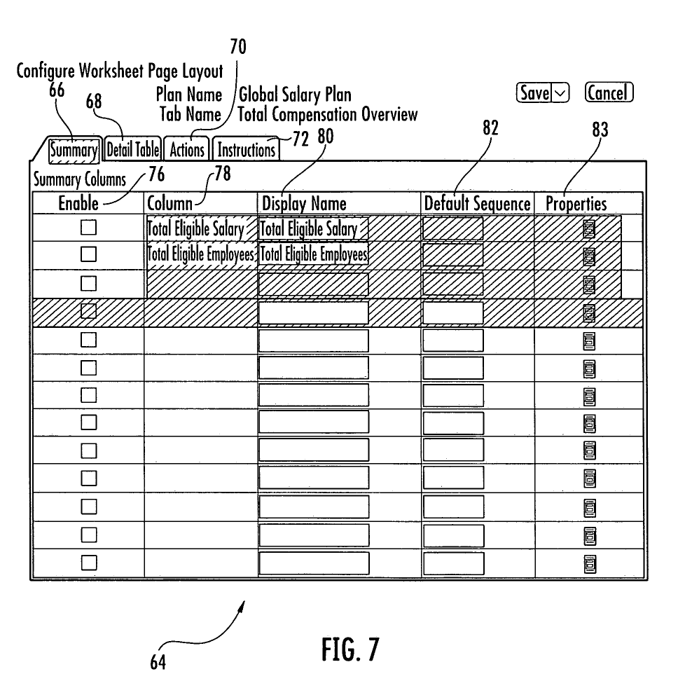

Page layout defining module 26 enables a user to configure the layout of each manager view. For example, page layout defining module 26 may be associated with the GUIs shown in FIGS. 7-10 according to some embodiments. Page layout defining module 26 allows the user to create the layout for each manager view according to several categories of layout characteristics. For example, page layout defining module 26 may be customized according to Summary information, Detail information, Actions, Instructions, etc.

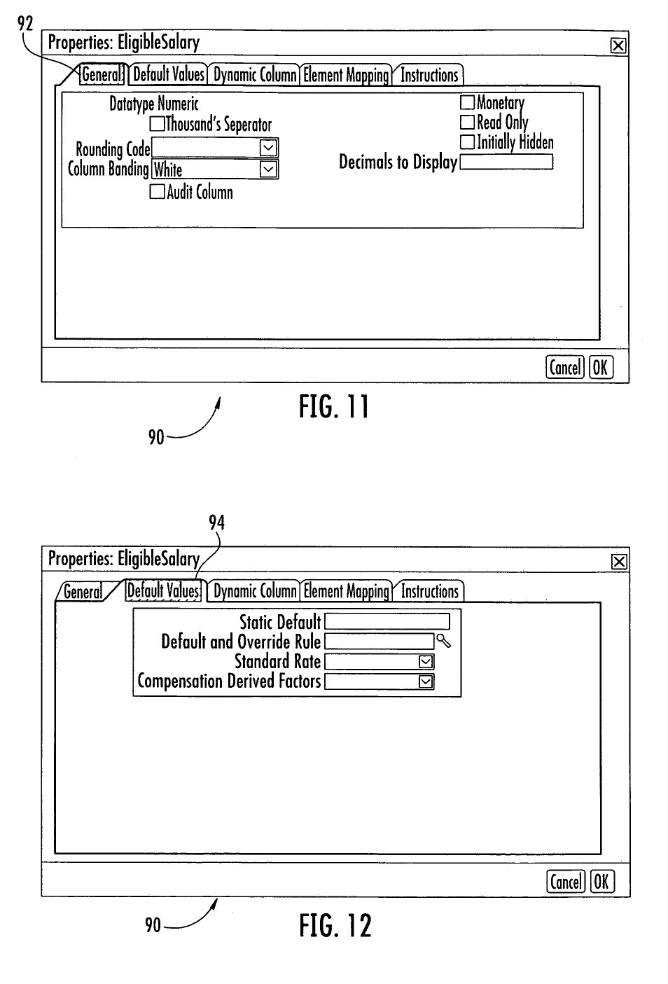

Column property defining module 28 enables the user to enter and/or select a number of advanced properties pertaining to each column arranged on a particular manager view. For example, column property defining module 28 may be associated with the GUIs shown in FIGS. 11-15 according to some implementations. Column property defining module 28 may allow the user to enter General information, Default information, Dynamic information, Element Mapping information, Instructions, etc.

Character/number/date handling module 30 can operate in the background of compensation module 20 to evaluate alphanumeric characters in a string of characters. Although calculations in typical compensation modules usually only include numbers, character/number/date handling module 30 moreover can handle a string of concatenated characters. In this respect, character/number/date handling module 30 is able to manage dates, which may include non-numeric characters, and other alphanumeric characters. Therefore, one or more columns of a worksheet or spreadsheet that are defined with alphanumeric characters can be broken down by character/number/date handling module 30 to handle the different aspects of the entries. Also, character/number/date handling module 30 can evaluate a monetary value by removing a non-numeric monetary symbol, such as “$,” and perform calculations on the numeric portion of the monetary entry.

In addition, since alphanumeric columns can be defined and evaluated by character/number/date handling module 30, various portions of the alphanumeric characters, which are concatenated strings of characters, can be extracted as needed. Date columns can also be defined and evaluated by the user using compensation module 20. Some examples of various conditions that can be entered in this system may include the following:

Total Compensation Amount=New Salary+Bonus+Monetary Value of Stock

Custom Name=Last Name+“,”+First Name+“:”+Country Code (e.g., US)

Next Data Refresh Date=Current Data Refresh Date+3 (which means that Next Data Refresh Date will be three days after the Current Data Refresh Date)

Total Work Experience=(Date of Joining−Data Freeze Date)+Previous Work Experience (where Data Freeze Date can be any date including the current date)

Also, currency conversion module 32, which may be used in parallel with character/number/date handling module 30, allows certain numbers to be defined as monetary values. In this case, monetary symbols can be evaluated by currency conversion module 32 to determine the monetary unit, which can be compare with respect to current exchange rates of other monetary units. In addition, currency conversion module 32 enables the user to convert from one monetary system to another, which might be based on the employee's country of residency or other factors.

FIG. 3 is a diagram showing an embodiment of a GUI 40 for enabling a user to configure the layout of a compensation management page. GUI 40 may be called up by a user using any suitable means, such as a mouse click on a button or icon within compensation module 20, for example. GUI 40 may include any suitable types of commands, including, for example, a selection of a Configure Worksheet Page Layout field 42. By selecting field 42, the user can bypass performing an actual process run and proceed to set-up pages for configuring a number of manager views of a compensation management page. Therefore, the compensation management page and its manager views can be defined without a participation process run of the compensation module 20, which may be any suitable compensation software application, e.g., Compensation Workbench from Oracle Corporation.

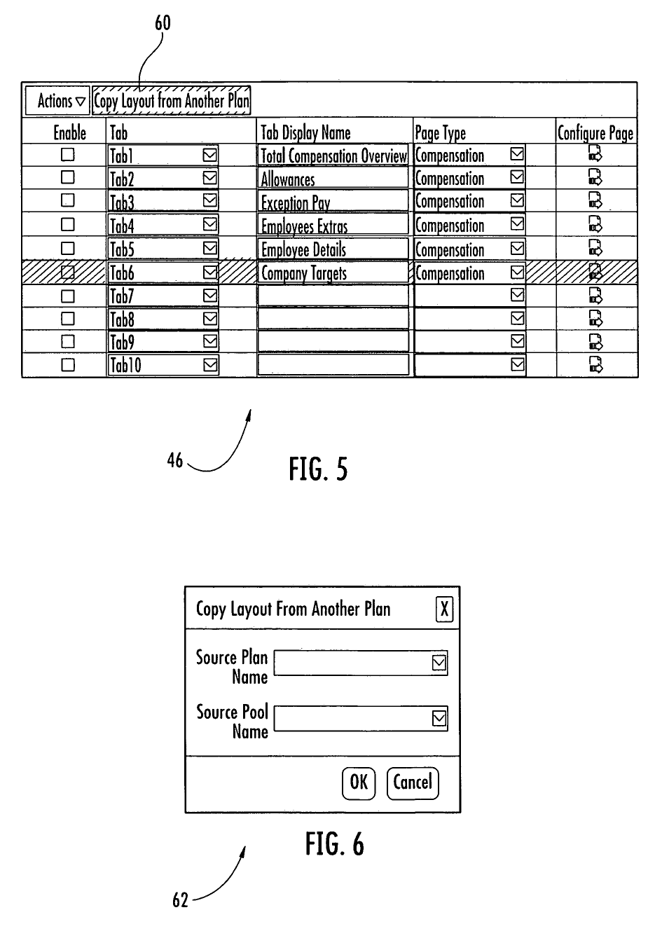

FIGS. 4 and 5 are diagrams illustrating an embodiment of a GUI 46 for enabling a user to group a number of manager views in a compensation management page. In some embodiments, GUI 46 shown in FIGS. 4 and 5 can be associated with the functionality of view grouping module 24 (FIG. 2). Each of the manager views can be defined with a specific display name and the views can be ordered in a specific rendering sequence. As shown in FIG. 4, GUI 46 includes an enable column 48, a tab column 50, a tab display name column 52, a page type column 54, and a configure page column 56. Tab column 50 includes a sequence of tabs, i.e., Tab1, Tab2, Tab3, and so on, which can be configured to allow access to a number of manager views. The tabs can be displayed for instance in numerical order from left to right near the top of the initial compensation management page displayed for the manager.

Enable column 48 allows the user to select the tabs to be displayed in the initial compensation management page for the manager's selection. Tab display name column 52 allows a user to enter the name of a number of tabs in the respective fields, which enable the manager to access a selected manager view. Page type column 54 allows the user to define the type of page by which the respective tab is represented. In this case, page type column 54 indicates that the manager views are represented as Compensation pages or views. Configure page column 56 provides an icon for each corresponding tab and allows the user to proceed to another set-up page to further configure or define specific properties of the respective manager view.

According to the examples described below with respect to FIGS. 7-10, the first tab (Tab1) is given the name “Total Compensation Overview” in a field 58 in tab display name column 52. When the icon in configure page column 56 corresponding to Tab1: Total Compensation Overview is selected, such as by a mouse click on the icon, a page layout GUI is opened, as explained below with respect to FIGS. 7-10, to allow the user to configure the page layout of the Total Compensation Overview manager view.

In the example of GUI 46 of FIG. 4, the first tab (Tab1) allows access to the page named Total Compensation Overview. Using page layout defining module 26 (FIG. 2), the Total Compensation Overview manager view may be configured by the user to include columns such as, for example, Employee Number, Employee Name, E-Mail, Manager, Hire Date, Previous Company, Work Location, Country, Job, Currency, Annual Salary, Total Bonus, Total Other Bonus, Total Commission, Total Exception Pay, Total Allowances, Total Cash Comp, Stock (shares), Stock (value), Walk-Away Value, Standard Hours, Working Hours, etc.

The second tab (Tab2) allows access to the page named Allowances. The Allowances manager view may be configured by the user to include columns such as, for example, Employee Number, Employee Name, E-Mail, Manager, Hire Date, Previous Company, Work Location, Country, Job, Currency, Annual Salary, Total Car Allowance, Total Cost-of-Living Allowance, Total Expense Allowance, Total Hardship Allowance, Total Housing Allowance, Total Transportation Allowance, Total Allowances, Standard Hours, Working Hours, etc.

The third tab (Tab3) allows access to the page named Exception Pay. The Exception Pay manager view may be configured by the user to include columns such as, for example, Employee Number, Employee Name, E-Mail, Manager, Hire Date, Previous Company, Work Location, Country, Job, Currency, Annual Salary, Regular Overtime Pay, Total Regular Overtime Hours, Total Double-Time pay, Total Double-Time Hours, Total Supplemental pay, Total Supplemental, Car Allowance, Total Shift Pay, Total Shift hours, Total Holiday Worked, Total Exception Pay, Standard Hours, Working Hours, etc.

The fourth tab (Tab4) allows access to the page named Employee Extras. The Employee Extras manager view may be configured by the user to include columns such as, for example, Manager's Notes, attachments, etc. The manager can access the attachments to view information from a Word document or Excel spreadsheet for justification of a specific employee compensation plan and for employee compensation history.

The fifth tab (Tab5) allows access to the page named Employee Details. The Employee Details manager view may be configured by the user to include columns such as, for example, Employee Name, Country, Years Worked, Years in Position, Years in Job, Location, Job, Position, Hire Date, Supervisor, Working Hours, E-Mail, etc.

The sixth tab (Tab6) allows access to the page named Company Targets. The Company Targets manager view may be configured by the user to include columns regarding organization-wide recommendations, such as, for example, Recommended Compensation Amount, Minimum Recommended Compensation Amount, Maximum Recommended Compensation Amount, Recommended Compensation Amount Range, etc.

By controlling how much information is placed on each page, the user can attempt to format the pages, if desired, such that a manager running the applications will not have to scroll down the user interface of the main compensation management page and view each entire manager view without scrolling as well. Therefore, the user may wish to create a certain number of views to distribute the configurable compensation information somewhat evenly among the views. All types of compensation can be defined by a tab, if desired, including salary, overtime pay, bonuses, stock options, profit sharing plans, bonus plans, life insurance, vacation pay, holiday pay, cleaning allowances, gasoline allowances, hotel accommodations, reimbursement for travel expenses, benefits, etc.

FIG. 5 is a diagram showing an embodiment of another view of GUI 46. In this example, a tab 60 labeled “Copy Layout from Another Plan” is available to the user. If tab 60 is selected, compensation module 20 opens GUI 62 shown in FIG. 6 to allow the user to pick a page layout that has been previously configured for another compensation plan. Thus, the layouts of other compensation plans that have already been configured can be copied and reused, if desired. According to FIG. 6, the embodiment of GUI 62 includes a first field to enter a Source Plan Name and a second field to enter a Source Pool Name. When the user does not wish to copy the page layouts from a previous plan, the user can arrange the grouping of views as mentioned with respect to FIG. 4.

FIGS. 7-10 are diagrams illustrating an embodiment of a GUI 64 for enabling a user to configure a page layout for a specific manager view. In some embodiments, GUI 64 shown in FIGS. 7-10 can be associated with the functionality of page layout defining module 26 (FIG. 2). In particular, the Worksheet Page Layout GUI 64 as shown can be used to configure the manager view associated with the tab “Total Compensation Overview” 58, which is shown in FIG. 4 and is accessed from Configure Page column 56. As shown in FIG. 7, GUI 64 includes a Summary tab 66, a Detail Table tab 68, an Actions tab 70, and an Instructions tab 72. In this example, GUI 64 is shown with Summary tab 66 open, which includes an “enable” column 76, a “column” column 78, a “display name” column 80, a “default sequence” column 82, and a “properties” column 83. Under the summary view, the user can add summary information for a particular manager view, which in this case is the Total Compensation Overview view. The user can configure each column of a summary region which will appear on the compensation management page for the manager during actual running of the compensation program. The user setting up the summary region can configure the summary according to taste and can configure each summary region differently for different pages.

When a manager view of a compensation management page is being viewed by a manager, the summary region and detail region can be displayed on the same manager view. The manager can choose to have either one or both of the regions displayed in the view and can minimize those that may not be needed at the time. In order to help the manager search for a specific column, both the summary region and detail region can support an inline search device, which allows the user to enter just part of a column name and the search device can fill in the rest of the name.

Referring again to FIG. 7, the view displayed within summary tab 66 includes a number of columns, which may be selected from a table of possible column names or can be entered as a customized column by the user. In this example, two columns are shown under “column” column 78—Total Eligible Salary and Total Eligible Employees. To enable the display of these columns, the user can select the respective box within enable column 76. Under display name column 80, the user can enter a name for each respective column. The default column 82 allows a user to enter a specific value or a specific calculation to be entered in the particular column. To further define properties of the respective columns, the user can click on the corresponding icon in properties column 83. In some embodiments, the user can decide whether or not to enter a graph to be displayed in the summary region.

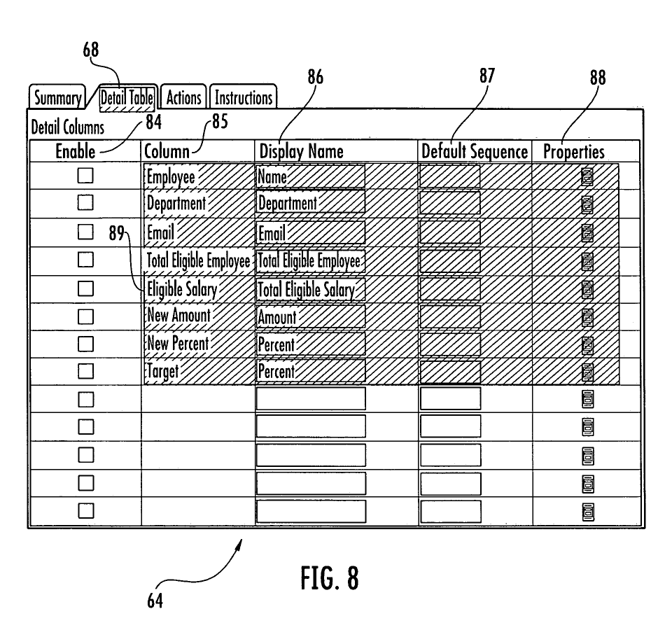

FIG. 8 shows another view of the embodiment of GUI 64. In this view, detail table tab 68 is selected, which includes an enable column 84, “column” column 85, display name column 86, default sequence column 87, and properties column 88. In can be seen that the set-up for entering information in the detail table tab 68 is similar to the set-up for the summary region. In this example, the columns listed in “column” column 85, as entered or selected by the user, include an Employee column, a Department column, an E-Mail column, a Total Eligible Employee column, an Eligible Salary column, a New Amount column, a New Percent column, and a Target column. These columns are represented by names as shown in display name column 86 that are substantially similar to the actual column content. The user can decide what is to be displayed as the display name at the heading for the respective columns and can modify the names as needed. The columns in one manager view can be given a display name that is different from the names for columns in other manager views.

The manager views can be configured to include any number of columns having any desired names. If the user chooses, the columns can be selected from a list of columns. For example, the columns can be broken up into separate categories to help the user narrow down to an acceptable name. In some embodiments, the categories of columns may include “Employee Detail Columns,” “Promotion Columns,” “Performance Columns,” “Compensation Columns,” and “Flexible Columns.”

Further defining the different categories of columns, the “Employee Detail Columns” may include Employee Name, Country, Years Worked, Years in Position, Years in Job, Years in Grade, Employee Number, Assignment Status, Organization, Location, Group, Job, Position, Grade, Original Date of Hire, Hire Date, Supervisor, Employment Category, Normal Hours, Payroll, Business Group, E-Mail, etc. The “Promotion Columns,” according to some embodiments, may include Job, Grade, Position, Group, Proposed Job, Proposed Grade, Proposed Position, etc. The “Performance Columns” in some embodiments may include Performance, Performance Rating Date, Rating Type, Proposed Rating, Rank, Direct Report's Rank, Direct Report, Ranking Quartile, etc. The “Flexible Columns” category may include a number of Custom Attribute—Text columns and a number of Custom Attribute—Numeric columns.

The category for “Compensation Columns” may include the selectable columns Base Salary—Current, Base Salary—New, Base Salary—Percent Change, Base Salary—Frequency, Adjustment Factor, Adjusted Salary—Current, Adjusted Salary—New, Adjusted Salary—Change Amount, and Adjusted Salary—Frequency. The Compensation Columns may also include FTE Factor, FTE Adjusted Salary—Current, FTE Adjusted Salary—New, and FTE Adjusted Salary—Change Amount. The “Compensation Columns” may also include Salary Range Low—Current, Salary Range High—Current, Salary Range Midpoint—Current, Salary Range Quartile—Current, Salary Range Quintile—Current, Salary Range Decile—Current, Salary Range Percentile—Current, Salary Range Compar-Ratio—Current, Current, Salary Range Quartile—New, Salary Range Quintile—New, Salary Range Decile—New, Salary Range Percentile—New, and Salary Range Compar-Ratio—New. “Compensation Columns” may also include a number of Compensation Amount columns, a number of Eligible Salary columns, a number of Percent of Eligible Salary columns, a number of Prior Period Amount columns, a number of Prior Period Amount Date columns, a number of Target Amount columns, a number of Target Maximum Amount columns, a number of Target Maximum Percent columns, a number of Target Minimum Amount columns, a number of Target Minimum Percent columns, a number of Target Percent columns, and a number of Target—Percent Deviation columns.

Default column 87 of detail table tab 68 of GUI 64 can be used to enter a sequence of columns, e.g., 100, 200, 300, 400, and so on. The user can set this order, which dictates how the manager will see the pages, i.e., 100 first, then 200, then 300, and so on. Properties column 88 includes icons that can be selected by the user to navigate to another user interface to enter further properties of a particular column. In the examples shown with respect to FIGS. 11-15 as described in more detail below, the column labeled Eligible Salary in field 89 is selected to allow the user to define configurable properties of the Eligible Salary column.

FIG. 9 shows an embodiment of a view of the embodiment of GUI 64 when Actions tab 70 is selected. In this case, a list of actions is shown that can be enabled by the user if desired. The user can make these actions available to the managers who run the compensation software. The user can therefore enable or disable certain manager actions for each manager view. The user can configure each manager view to be associates with any combination of Actions.

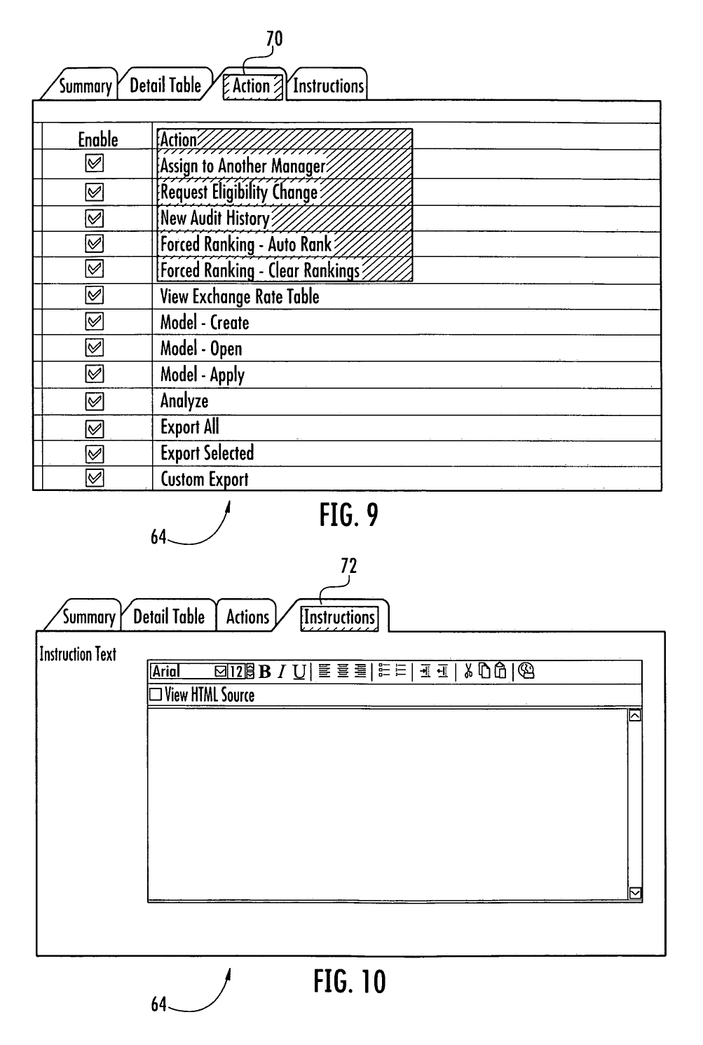

FIG. 10 shows an embodiment of GUI 64 when Instructions tab 72 is selected. The user can enter instructions that can be viewed by the managers when running the software. The instructions can help to throw light on a particular view and provide a rationale or explanation for the content or meaning of the columns. For example, if a column Total Compensation is included in a manager view, an instruction icon can be selected to explain to the manager that the column Total Compensation is equal to, say, Salary+Bonus+Monetary Stock Amount for that employee or group of employees. The user can enter instructions that are defined for all the manager views of an entire compensation management page or for less than all the manager views. The instructions are thereby rendered on the page being viewed to define aspects of the views. In other embodiments described below, additional instructions can be entered on the column level to provide instructions or information relevant to the particular columns.

FIGS. 11-15 are diagrams illustrating an embodiment of a GUI 90 for enabling a user to configure properties of a specific column of a specific manager view. In some embodiments, GUI 90 shown in FIGS. 11-15 can be associated with the functionality of column property defining module 28 (FIG. 2). In this example, a selection is made of field 89 (FIG. 8) corresponding to the column Eligible Salary and given the display name “Total Eligible Salary.” In particular, the icon under properties column 88 (FIG. 8) corresponding to the Eligible Salary column can be clicked to bring up GUI 90 of FIG. 11.

FIG. 11 shows an embodiment of GUI 90 when a General tab 92 is selected. In this regard, the General view shows a number of general items that the user can configure for the selected column, i.e., Eligible Salary column in this case, as desired. More particularly, the user can select whether to display a thousands separator by checking the box next to “Thousand's separator.” The Rounding Code determines how to round numeric fields. The Column Shading determines if a specific column will be shaded or not. A mark for Audit can be checked if the column is to be included in an audit report. The Monetary mark can be checked to identify a column as containing monetary amounts, which will allow the column to be subject to currency conversion. If a column is not monetary, then the field can be defined for any suitable unit of measure, e.g., Number of Stocks, etc. The Read Only box can be checked to specify that a column is not updateable. The box for the Initially Hidden field can be checked to hide the contents of the column from the managers. The Decimals to Display box can be checked to set how many decimals are to be displayed for numeric fields. Also, the user can configure general properties of the column for a Numeric Display Format, which determines what formatting to use in numeric fields.

FIG. 12 shows an embodiment of a view of GUI 90 when a Default Values tab 94 is selected. These default values can be applied to the respective columns. For example, the default value may include a Static Default, which provides an initial default value. The Default and Override Rule can be defined to derive the column value based on rules defined by a user. Also, entries can be made into a Standard Rate field and/or a Compensation Derived Factors field.

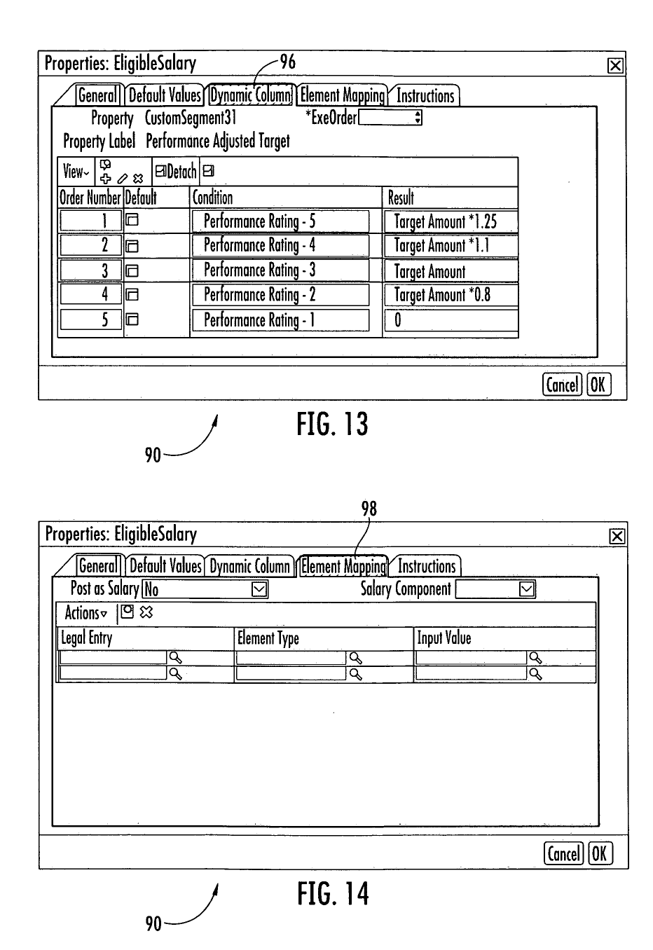

FIG. 13 shows an embodiment of a view of GUI 90 when a Dynamic Column tab 96 is selected. Within the dynamic column view, a Dynamic Calculation can be entered, which derives a value for one column upon the entry or update of values in another column or columns. The columns of a manager view can be configured to perform a dynamic calculation, which involves calculating an equation for one column based on the values in one or more other columns. The dynamic calculations can be defined irrespective of whether the column is numeric or non-numeric. In the example shown in FIG. 13, a Target Amount in a Result column is calculated based on a value given to a Performance Rating in a Condition column.

FIG. 14 shows an embodiment of a view of GUI 90 when an Element Mapping tab 98 is selected. Within the Element Mapping view, element mapping fields can be entered to specify whether a column is a Salary Column or some other predefined compensation column. The user can also enter whether a value of a column is to be posted to payroll.

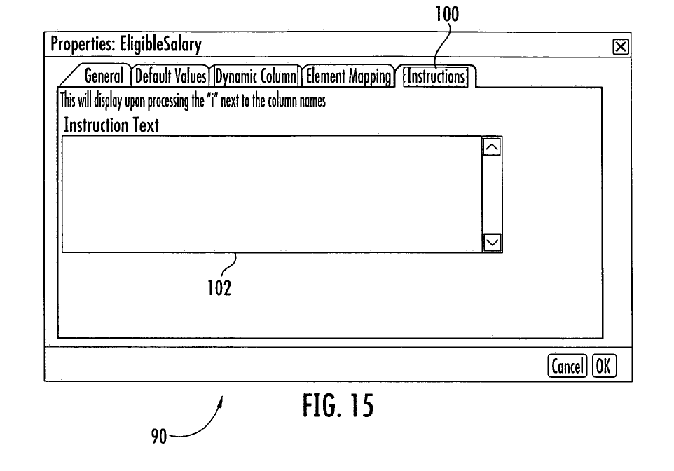

FIG. 15 shows an embodiment of a view of GUI 90 when an Instructions tab 100 is selected. In this view, an Instruction Text window 102 is opened, which allows the user to enter instructional text. The text entered in Instruction Text window 102 is intended as help for the managers as they run the compensation program. Then, when the compensation software application is actually run by the manager, compensation module 20 is configured to place an icon next to the applicable column name to indicate that instructions are available regarding the respective column. If the manager clicks on the icon, then a window is opened showing the instructional text.

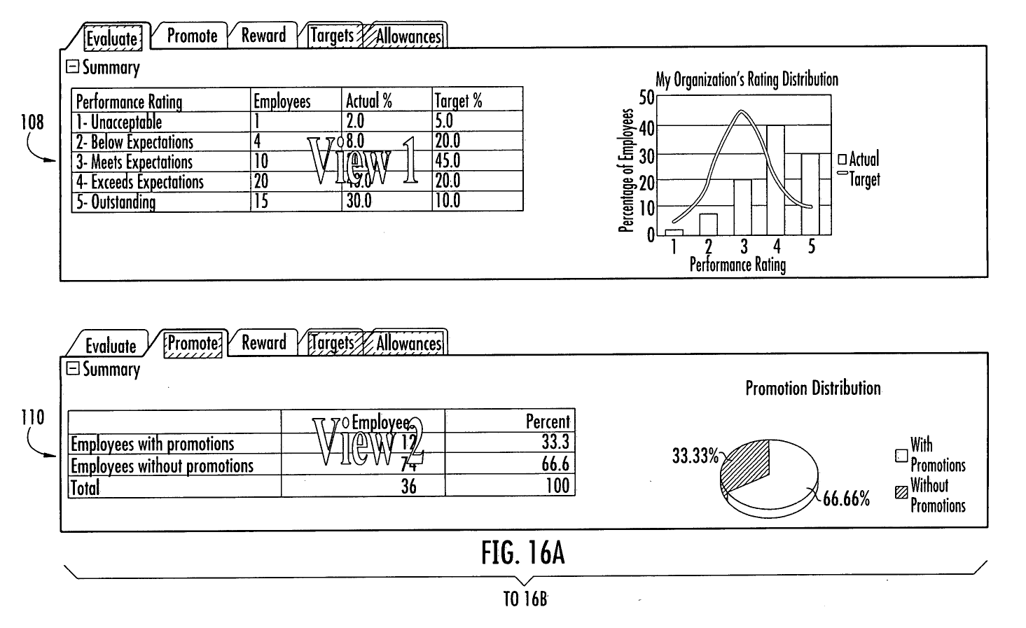

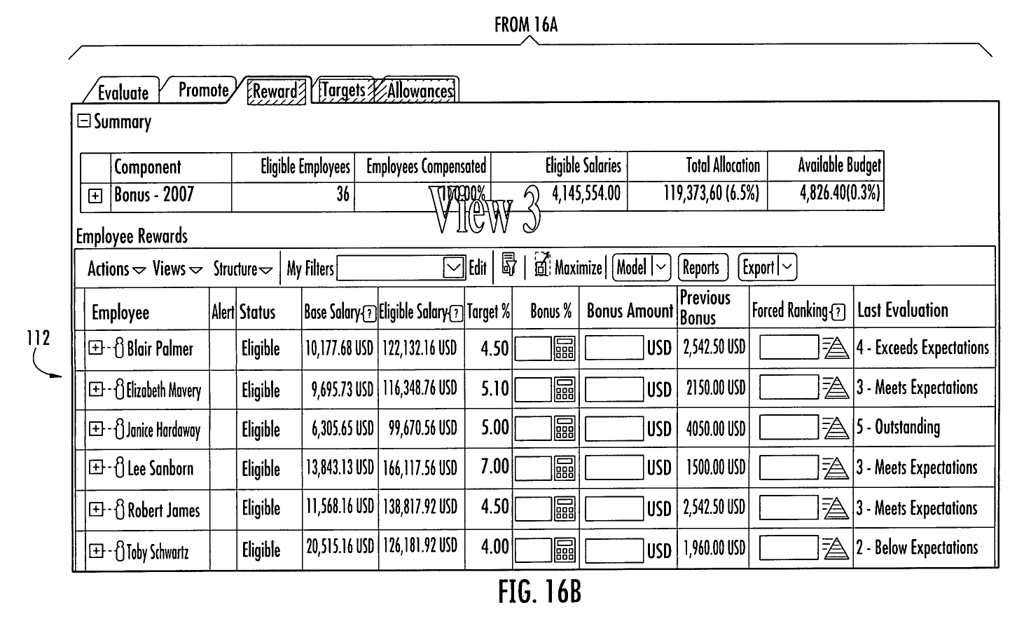

FIG. 16 is a diagram illustrating a number of examples of manager views of a compensation management page. The manager views, which are set up by the user according to the description of FIGS. 2-15, are displayed as shown to a manager operating the compensation software. A first manager view (View 1) is shown in the upper portion 108 of FIG. 16 when a first tab, e.g., Evaluate tab, is selected. The first tab can also be the default tab that is initially displayed for the manager's viewing. In this Evaluate view, the summary region shows a number of columns that have been entered by the user. Particularly, the columns include a Performance Rating column, an Employees column, an Actual % column, and a Target % column. Graphs can also be displayed based on the particular design. In this example, a graph of “My Organization's Rating Distribution” is shown in the summary region.

A second manager view (View 2) is shown in the middle portion 110 of FIG. 16 when a second tab, e.g., Promote tab, is selected. Promote manager view includes a summary region of promotion distribution information and a graph. A third view (View 3) is shown at a bottom portion 112 of FIG. 16 when a third tab, e.g., Reward tab, is selected. In the Reward view, a summary view is shown with a Component column, an Eligible Employees column, an Employees Compensated column, an Eligible Salaries column, a Total Allocation column, and an Available Budget column. The Reward view also includes a detailed view including Employee Rewards.

The details table is usually configured to be shown in all the manager views (or sub-tabs). Each view (or sub-tab) will have a details table, which will be visible just below the summary information for that view. Details table includes an area where a manager can enter compensation information for employees. For example, in a Bonus Award Plan, the manager can enter data for a bonus amount in a bonus column for the employees in the details table. The summary information at the top of the view summarizes the values in the details table for the manager's benefit. The detailed view, according to the user's entries, includes an Employee column, an Alert column, a Status column, a Base Salary column, an Eligible Salary column, a Target % column, a Bonus % column, a Bonus Amount column, a Previous Bonus column, a Forced Ranking column, and a Last Evaluation column. It should be understood that the detailed view is not limited to these columns, but can be configured in any desired manner by the user.

The columns of a manager view can be configured to include instructions, which may be defined during the set-up process, as described above with respect to FIG. 15. The extra instructions can be accessed by the manager via an icon, which may be positioned next to a column name in the manager's worksheet. In this example, the columns for Base Salary, Eligible Salary, and Forced Ranking of View 3 include icons (in the form of question marks) that are displayed next to the column names. The manager can request to view the instructions by clicking on the respective icon, which causes the column property defining module 28 (FIG. 2) to display the user-entered instructions.

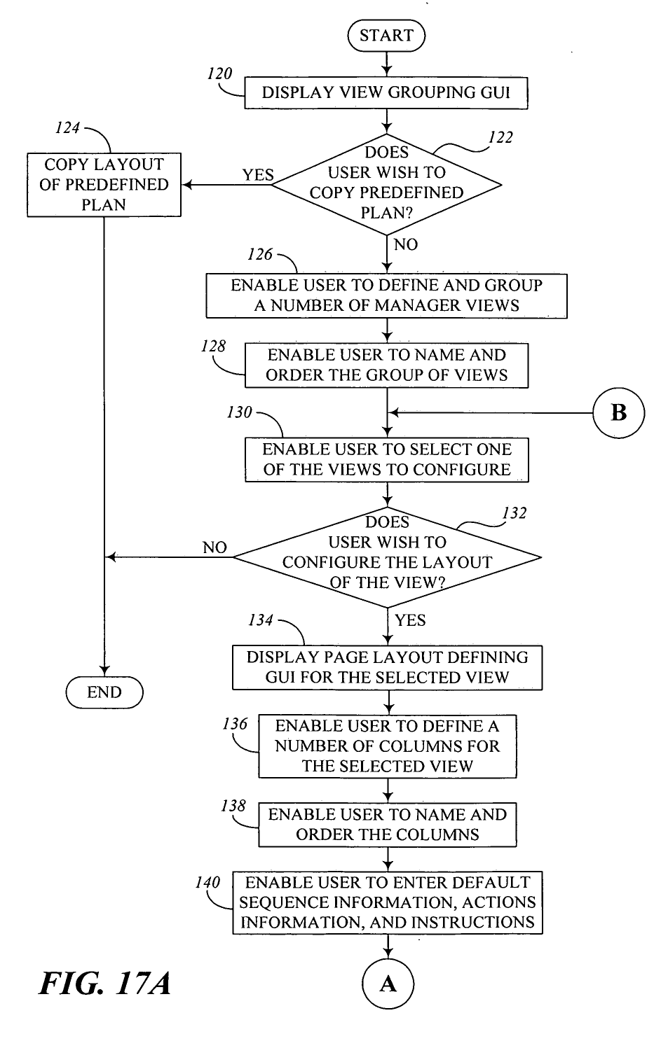

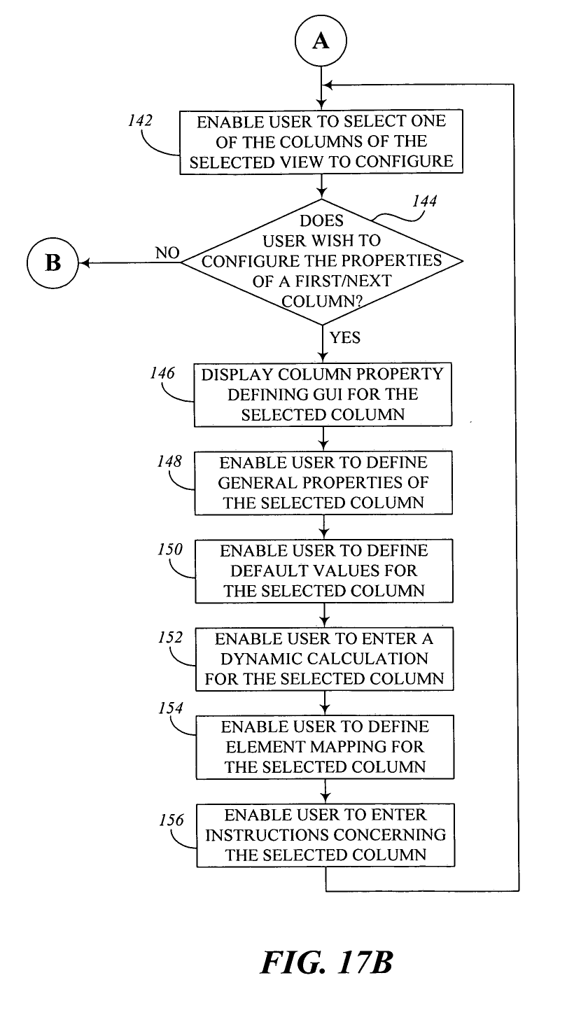

FIGS. 17A and 17B together form a flow diagram illustrating an embodiment of a computer implemented method for setting up compensation management pages. According to this embodiment, the method includes displaying a view grouping GUI, as indicated in block 120. According to decision block 122, it is determined whether or not the user wishes to copy a page layout from a predefined plan. If it is determined that the user wishes to copy a predefined plan, the method proceeds to block 124, which indicates that the layout of another plan can be selected and the pages and views of the predefined plan are copied, and the method ends. If the user does not wish to copy a predefined plan, the method proceeds to block 126.

As indicated in block 126, the user is enabled to define and group a number of manager views. As indicated in block 128, the user is enabled to name and order the group of views. As indicated in block 130, the user is enabled to select one of the manager views in order to configure that view. In decision block 132, it is determined whether or not the user wishes to configure the layout of the particular view. If not, then the method ends. Otherwise, the method proceeds to block 134, which indicates that a page layout defining GUI is displayed to allow configuration of the selected manager view. As indicated in block 136, the user is enabled to define a number of columns for the selected view. As indicated in block 138, the user is enabled to name and order the columns of the selected view. As indicated in block 140, the user is enabled to enter default sequence information, actions information, and instructions for the selected view.

As indicated in block 142 (shown in FIG. 17B), the method further includes enabling the user to select one of the columns of the selected manager view in order to configured that column. In decision block 144, it is determined whether or not the user wishes to configure the properties of a first column (or another column if this process is repeated at a later time). If the user does not wish to configure the properties of the column, the method returns back to block 130 (FIG. 17A) to enable the user to select another manager view to configure. If it is determined in block 144 that the user wishes to configure the properties of a column, the method proceeds to block 146, which indicates that a column property defining GUI is displayed for the selected column.

As indicated in block 148, the method includes enabling the user to define general properties of the selected column. As indicated in block 150, the user is enabled to define default values for the selected column. As indicated in block 152, the user is enabled to enter a dynamic calculation for the selected column. As indicated in block 154, the user is enabled to define element mapping for the selected column. As indicated in block 156, the user is enabled to enter instructions concerning the selected column. After enabling the user to configure the properties of the selected column as described with respect to blocks 148, 150, 152, 154, and 156, the method loops back to block 142 to allow the user to select another column if the user wishes.

It should be understood that the steps, processes, or operations described herein may represent any module or code sequence that can be implemented in software or firmware. In this regard, these modules and code sequences can include commands or instructions for executing specific logical steps, processes, or operations within physical components. It should further be understood that one or more of the steps, processes, and/or operations described herein may be executed substantially simultaneously or in a different order than explicitly described, as would be understood by one of ordinary skill in the art.

The embodiments described herein represent a number of implementations and examples and are not intended to necessarily limit the present disclosure to any specific embodiments. Instead, various modifications can be made to these embodiments as would be understood by one of ordinary skill in the art. Any such modifications are intended to be included within the spirit and scope of the present disclosure and protected by the following claims.

We claim:

1. A compensation module for managing compensation information for a plurality of employees, the compensation module comprising:
a set-up module having a view grouping module, a page layout defining module, and a column property defining module, wherein the set-up module is configured to enable a user to set-up and define manager views of a compensation management page without affecting actual compensation data;
the view grouping module configured to enable a user to group a plurality of manager views, the page layouts of which are to be set up by the user;
the page layout defining module configured to enable the user to define the layout of one or more of the plurality of manager views; and
the column property defining module configured to enable the user to define one or more columns of each of the manager views.

2. The compensation module of claim 1, wherein the view grouping module is further configured to enable the user to name each manager view.

3. The compensation module of claim 1, wherein the view grouping module is further configured to enable the user to arrange the plurality of manager views in a specific order.

4. The compensation module of claim 3, wherein the view grouping module is further configured to display a tab for each manager view, the tabs displayed in the specific order arranged by the user.

5. The compensation module of claim 1, wherein the view grouping module is further configured to enable a user to select between a first action of copying a layout of a group of manager views from a predefined compensation plan and a second action of grouping the plurality of manager views.

6. The compensation module of claim 1, wherein the page layout defining module is further configured to enable the user to define a number of columns for display in each manager view.

7. The compensation module of claim 6, wherein the page layout defining module is further configured to enable the user to select at least one column for display in the manager views from a list of predefined columns.

8. The compensation module of claim 6, wherein the page layout defining module is further configured to enable the user to name each column of each manager view.

9. The compensation module of claim 6, wherein the page layout defining module is further configured to enable the user to arrange the columns of a specific manager view in a specific order.

10. The compensation module of claim 1, wherein the page layout defining module is further configured to enable the user to select one or more predefined actions.

11. The compensation module of claim 1, wherein the page layout defining module is further configured to enable the user to enter instructions, the page layout defining module further configured to display the instructions to a manager who is allowed to access the manager views.

12. The compensation module of claim 1, wherein the column property defining module is further configured to enable the user to select general information about each column, the general information including at least one of a thousands separator feature, a rounding code feature, a column banding feature, a feature to mark a column for audit purposes, a number of decimals to display feature, a monetary identifier, a read-only identifier, and a hidden information identifier.

13. The compensation module of claim 1, wherein the column property defining module is further configured to enable the user to enter default values for one or more columns.

14. The compensation module of claim 1, wherein the column property defining module is further configured to enable the user to enter a dynamic calculation for one or more columns.

15. The compensation module of claim 1, wherein the column property defining module is further configured to enable the user to map an element for one or more columns.

16. The compensation module of claim 1, wherein the column property defining module is further configured to enable the user to enter instructions for one or more columns, the column property defining module further configured to display the instructions in response to a request from a manager who is allowed to access the one or more columns.

17. A computer readable medium configured to store instructions that are executable by a processing device, the computer readable medium comprising:
logic adapted to enable a user to set up and define manager views of a compensation management page without affecting actual compensation data;
logic adapted to enable a user to group a plurality of manager views, the layouts of which are to be set up by the user;
logic adapted to enable a user to define the layout of each of the plurality of manager views; and
logic adapted to enable a user to define one or more columns of each manager view.

18. The computer readable medium of claim 17, wherein the logic adapted to enable the user to group the manager views is further adapted to enable the user to copy a layout from predefined pages.

19. The computer readable medium of claim 17, wherein the logic adapted to enable the user to group the manager views is further adapted to enable the user to arrange the manager views in a specific order.

20. The computer readable medium of claim 17, wherein the logic adapted to enable the user to define the layout of the manager views is further adapted to enable the user to arrange a number of columns of each manager view in a specific order.

21. The computer readable medium of claim 17, wherein the logic adapted to enable the user to define the columns of the manager views is further adapted to enable the user to select characteristics related to at least one of a thousand's separator, a rounding code, column banding, an audit flag, a number of decimals to display, a monetary cell identifier, a read-only identifier, and a hidden information identifier.

22. A system comprising:
means for enabling a user to set-up and define manager views of a compensation management page without affecting actual compensation data;
means for enabling a user to select between a first action of copying a layout of a group of manager views from a predefined layout and a second action of grouping a plurality of manager views, the layouts of which are to be set up by the user;
means for enabling the user to define the layout of one or more of the plurality of manager views; and
means for enabling the user to define one or more columns of one of the manager views.

23. The system of claim 22, further comprising:
means for enabling the user to name each manager view and arrange the manager views in a specific order; and
means for displaying a tab for each manager view in the specific order arranged by the user.

24. The system of claim 22, further comprising:
means for enabling the user to define and name a number of columns for display on each manager view; and
means for enabling the user to arrange the columns of a specific manager view in a specific order.

25. The system of claim 22, further comprising means for enabling the user to enter instructions that are accessible through the manager views.

26. The system of claim 22, further comprising:
means for enabling the user to enter or select information regarding a thousands separator feature, a rounding code feature, a column banding feature, a feature to mark a column for audit purposes, a number of decimals to display feature, a monetary identifier, a read-only identifier, and a hidden information identifier;
means for enabling the user to enter or select default values for one or more columns;
means for enabling the user to enter a dynamic calculation for one or more columns;
means for enabling the user to map an element for one or more columns; and
means for enabling the user to enter instructions for one or more columns.

27. A computer implemented method comprising:
enabling a user to set-up and define manager views of a compensation management page without a participation process run;
enabling the user to group a plurality of manager views, the layouts of which are to be set up by the user;
enabling the user to define the layout of each of the plurality of manager views; and
enabling the user to define each column of each manager view.

28. The method of claim 27, wherein enabling the user to group the manager views further comprises enabling the user to arrange the manager views in a specific order.

29. The method of claim 27, wherein enabling the user to define the layout of the manager views further comprises enabling the user to arrange a number of columns of each manager view in a specific order.

30. The method of claim 27, wherein enabling the user to define the columns of the manager views further comprises enabling the user to select characteristics related to at least one of a thousand's separator, a rounding code, column banding, an audit flag, a number of decimals to display, a monetary cell identifier, a read-only identifier, and a hidden information identifier.

31. The method of claim 27, further comprising:
offering an option to a user to copy a group of manager views from a predefined layout; and
if the user selects the option to copy the group of manager views, then copying the predefined pages of the layout.
